(19) United States
(12) Patent Application Publication
(10) Pub. No.: US 2024/0064127 A1
(43) Pub. Date: Feb. 22, 2024

(54) METHOD AND SYSTEM FOR INTEGRATION OF NETWORK SLICE ENCRYPTION

(71) Applicant: Verizon Patent and Licensing Inc., Basking Ridge, NJ (US)

(72) Inventors: David Taft, Keller, TX (US); Anthony Clay Reynolds, Rhome, TX (US); Lap Tse, Marietta, GA (US); Jerry Steben, Fort Worth, TX (US); Sudhakar Reddy Patil, Flower Mound, TX (US); John A. Darpino, Elmer, NJ (US); Maqbool Chauhan, Keller, TX (US)

(21) Appl. No.: 17/821,233

(22) Filed: Aug. 22, 2022

(51) Int. Cl. H04L 9/40

(52) U.S. Cl. CPC H04L 63/0428

(57) ABSTRACT

A method, a network device, and a non-transitory computer-readable storage medium are described in relation to an integrated network slice encryption service. The integrated network slice encryption service may manage and provision encryption and/or decryption services associated with a third party and relative to a network slice and end device application associated with a service provider and application provider. The integrated network slice encryption service may provision end devices, core network devices, and application layer devices of an external network.

### BACKGROUND

Development and design of networks present certain challenges from a network-side perspective and an end device perspective. For example, Next Generation (NG) wireless networks, such as Fifth Generation New Radio (5G NR) networks are being deployed and are under development.

### BRIEF DESCRIPTION OF THE DRAWINGS

FIG. 1 is a diagram illustrating an exemplary environment in which an exemplary embodiment of an integrated network slice encryption service may be implemented;

FIGS. 2A-2C are diagrams illustrating an exemplary process of an exemplary embodiment of the integrated network slice encryption service;

FIG. 3 is a diagram illustrating exemplary components of a device that may correspond to one or more of the devices illustrated and described herein;

FIG. 4 is a flow diagram illustrating an exemplary process of an exemplary embodiment of the integrated network slice encryption service; and

FIG. 5 is a flow diagram illustrating another exemplary process of an exemplary embodiment of the integrated network slice encryption service.

### DETAILED DESCRIPTION

The following detailed description refers to the accompanying drawings. The same reference numbers in different drawings may identify the same or similar elements. Also, the following detailed description does not limit the invention.

Typically, communications within a network are supported by a security mechanism, such as encryption, authentication, authorization, and/or other types of security-related measures. In a wireless network, a standards body, such as Third Generation Partnership Project (3GPP), 3GPP2, International Telecommunication Union (ITU), European Telecommunications Standards Institute (ETSI), GSM Association (GSMA), and the like, may proffer technical specifications that address security between user equipment (UE) and a mobile and/or wireless network. However, such standards do not account for a per network slice encryption that is integrated between an application, a mobile network, and a third party security entity, which may add additional layer of security protection.

According to exemplary embodiments, an integrated network slice encryption service is described. The integrated network slice encryption service may provide network slice and end-to-end application layer encryption and decryption services. According to an exemplary embodiment, a third party device may select and provision user plane devices of a network slice belonging to a network not operated by the third party to provide the integrated network slice encryption service for a prospective end device application service session. The user plane devices may encrypt and/or decrypt application data (e.g., in a payload of a packet) according to the provisioning. According to an exemplary embodiment, the user plane devices may include user equipment (UE), a user plane function (UPF) (e.g., of a core network), and an application service layer device (e.g., an application server or the like).

According to an exemplary embodiment, the user plane devices may each include logic that provides the integrated network slice encryption service and configured to be provisioned by the third party device, as described herein. For example, the user plane device may include an encryption/decryption algorithm and a key management system. The user plane device may include a key generation function.

In view of the foregoing, the integrated network slice encryption service may provide selection and configuration of third party encryption/decryption integrated with an end device, a wireless network (e.g., a radio access network, a core network) and an application service layer network (e.g., an external network, a data network, and like), as described herein. In this way, the integrated network slice encryption service may provide an additional layer of security protection for user plane traffic and application service sessions between the end device, the wireless network, and an application service layer network.

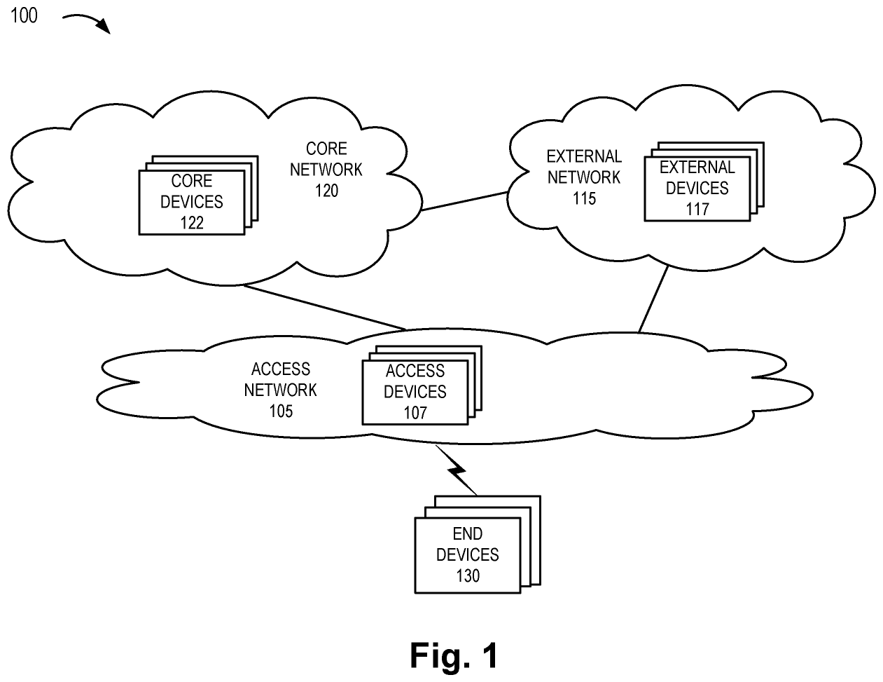

FIG. 1 is a diagram illustrating an exemplary environment 100 in which an exemplary embodiment of an integrated network slice encryption service may be implemented. As illustrated, environment 100 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 100 further includes end devices 130 (also referred to individually or generally as end device 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network (e.g., Signaling System No. 7 (SS7), etc.), or another type of network that may support a wireless service and/or an application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), virtual, logical, network slice, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communicative connection may not involve an intermediary device and/or an intermediary network. The number, type, and arrangement of communication links illustrated in environment 100 are exemplary.

Environment 100 may include various planes of communication including, for example, a control plane, a user plane, a service plane, and/or a network management plane. Environment 100 may include other types of planes of communication. A message communicated in support of the integrated network slice encryption service may use at least one of these planes of communication. Additionally, an interface of a network device may be modified (e.g., relative to an interface defined by a standards body, such as Third Generation Partnership Project (3GPP), 3GPP2, International Telecommunication Union (ITU), European Telecommunications Standards Institute (ETSI), GSM Association (GSMA), and the like) or a new interface of the network device may be provided in order to support the communication (e.g., transmission and reception of messages, an information element (IE), an attribute value pair (AVP), an object, a header, a parameter, or another form of a data instance) between network devices and the integrated network slice encryption service logic of the network device. According to various exemplary implementations, the interface of the network device may be a service-based interface, a reference point-based interface, an Open Radio Access Network (O-RAN) interface, a 5G interface, another generation of interface (e.g., 5.5G, Sixth Generation (6G), Seventh Generation (7G), etc.), or some other type of network interface.

Access network 105 may include one or multiple networks of one or multiple types and technologies. For example, access network 105 may be implemented to include a 5G RAN, a future generation RAN (e.g., a 6G RAN, a 7G RAN, or a subsequent generation RAN), a centralized-RAN (C-RAN), an O-RAN, and/or another type of access network. Access network 105 may include a legacy RAN (e.g., a Third Generation (3G) RAN, a Fourth Generation (4G) or 4.5 RAN, etc.). Access network 105 may communicate with and/or include other types of access networks, such as, for example, a Wi-Fi network, a Worldwide Interoperability for Microwave Access (WiMAX) network, a local area network (LAN), a Citizens Broadband Radio System (CBRS) network, a cloud RAN, an O-RAN network, a virtualized RAN (vRAN), a self-organizing network (SON), a wired network (e.g., optical, cable, etc.), or another type of network that provides access to or can be used as an on-ramp to access network 105.

Depending on the implementation, access network 105 may include one or multiple types of network devices, such as access devices 107. For example, access device 107 may include a gNB, an evolved Long Term Evolution (eLTE) evolved Node B (eNB), an eNB, a radio network controller (RNC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 6G wireless station, a 7G wireless station, or another generation of wireless station), another type of wireless node (e.g., a WiFi device, a WiMax device, a hotspot device, etc.) that provides a wireless access service, or another type of network device that provides a transport service (e.g., routing and forwarding), such as a router, a switch, or another type of layer 3 (e.g., network layer of the Open Systems Interconnection (OSI) model) network device.

According to an exemplary embodiment, at least some of access devices 107 include logic of the integrated network slice encryption service, as described herein. For example, access device 107 may transmit and receive messages pertaining to the integrated network slice encryption service, as described herein.

External network 115 may include one or multiple networks of one or multiple types and technologies that provides an application service. For example, external network 115 may be implemented using one or multiple technologies including, for example, network function virtualization (NFV), software defined networking (SDN), cloud computing, Infrastructure-as-a-Service (IaaS), Platform-as-a-Service (PaaS), Software-as-a-Service (SaaS), or another type of network technology. External network 115 may be implemented to include a cloud network, a private network, a public network, a multi-access edge computing (MEC) network, a fog network, the Internet, a packet data network (PDN), a service provider network, the World Wide Web (WWW), an Internet Protocol Multimedia Subsystem (IMS) network, a Rich Communication Service (RCS) network, a software-defined (SD) network, a virtual network, a packet-switched network, a data center, a data network, or other type of network that may provide access to and may host an end device application service.

Depending on the implementation, external network 115 may include various network devices such as external devices 117. For example, external devices 117 may include virtual network devices (e.g., virtualized network functions (VNFs), servers, host devices, application functions (AFs), application servers (ASs), server capability servers (SCSs), containers, hypervisors, virtual machines (VMs), network function virtualization infrastructure (NFVI), and/or other types of virtualization elements, layers, hardware resources, operating systems, engines, etc.) that may be associated with application services for use by end devices (not illustrated). By way of further example, external devices 117 may include mass storage devices, data center devices, NFV devices, SDN devices, cloud computing devices, platforms, and other types of network devices pertaining to various network-related functions (e.g., security, management, charging, billing, authentication, authorization, policy enforcement, development, etc.). Although not illustrated, external network 115 may include one or multiple types of core devices 122, as described herein.

External devices 117 may host one or multiple types of application services. For example, the application services may pertain to broadband services in dense areas (e.g., pervasive video, smart office, operator cloud services, video/photo sharing, etc.), broadband access everywhere (e.g., 50/100 Mbps, ultra-low-cost network, etc.), enhanced mobile broadband (eMBB), higher user mobility (e.g., high speed train, remote computing, moving hot spots, etc.), Internet of Things (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, conferencing, instant messaging), video streaming, and/or other types of wireless and/or wired application services. External devices 117 may also include other types of network devices that support the operation of external network 115 and the provisioning of application services, such as an orchestrator, an edge manager, an operations support system (OSS), a local domain name system (DNS), registries, and/or external devices 117 that may pertain to various network-related functions (e.g., security, management, charging, billing, authentication, authorization, policy enforcement, development, etc.). External devices 117 may include non-virtual, logical, and/or physical network devices.

According to an exemplary embodiment, at least some of external devices 117 may include logic on how to interact with the integrated network slice encryption service, as described herein. For example, a third party device may communicate with end device 130, core device 122, and other external device 117 (e.g., that may host an application service) and may provision and/or activate an encryption/decryption service at the application level for a network slice and end-to-end. According to an exemplary embodiment, the third party device may include a security device. For example, the third party device may include an AAA device, an encryption management device, a key management device, and/or another type of security device that provide the encryption service (e.g., a policy device, a key generator, etc.).

According to an exemplary embodiment, a strength of the encryption may vary among different network slices and/or end device application services provided via a network slice. For example, depending on the network slice and/or the end device application service, the encryption/decryption service may afford low, medium, high, or another category or level of security end-to-end. According to another exemplary embodiment, the strength of the encryption may be uniformly applied regardless of the network slice and/or the end device application service. According to still other exemplary embodiments, other criteria may be considered for the provisioning of the encryption/decryption service, such as the type of end device 130 (e.g., IoT device versus a mobile phone due to different processor capabilities, an access category of end device 130, and/or another feature associated with end device 130), a characteristic of an external network 115 that may host the end device application service (e.g., public network versus private network, etc.), a quality of service (QoS) metric value associated with the end device application service (e.g., a latency value, a throughput value, and/or another performance metric value), and/or other configurable criteria.

According to an exemplary embodiment, as described, another external device 117 (e.g., that may host an application service) may include logic of the integrated network slice encryption service, as described herein. For example, the other external device 117 may include software that provides the encryption/decryption service at the application level (e.g., associated with the application service) for a network slice and end-to-end relative to an application service session (e.g., a packet data unit (PDU) session) with end device 130 via access network 105 and core network 120.

Core network 120 may include one or multiple networks of one or multiple network types and technologies. Core network 120 may include a complementary network of access network 105. For example, core network 120 may be implemented to include a 5G core network, an evolved packet core (EPC) of an LTE network, an LTE-Advanced (LTE-A) network, and/or an LTE-A Pro network, a future generation core network (e.g., a 5.5G, a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a user plane function (UPF) (which may include a NW-TT), a Non-3GPP Interworking Function (N3IWF), an access and mobility management function (AMF), a session management function (SMF), a unified data management (UDM) device, a unified data repository (UDR), an authentication server function (AUSF), a network slice selection function (NSSF), a network repository function (NRF), a policy control function (PCF), a network data analytics function (NWDAF), a network exposure function (NEF), a service capability exposure function (SCEF), a lifecycle management (LCM) device, a TSCTSF, a mobility management entity (MME), a packet data network gateway (PGW), an enhanced packet data gateway (ePDG), a serving gateway (SGW), a home agent (HA), a General Packet Radio Service (GPRS) support node (GGSN), a home subscriber server (HSS), an authentication, authorization, and accounting (AAA) server, a policy and charging rules function (PCRF), a policy and charging enforcement function (PCEF), and/or a charging system (CS).

According to other exemplary implementations, core devices 122 may include additional, different, and/or fewer network devices than those described. For example, core devices 122 may include a non-standard or a proprietary network device, and/or another type of network device that may be well-known but not particularly mentioned herein. Core devices 122 may also include a network device that provides a multi-RAT functionality (e.g., 4G and 5G, 5G and 5.5G, 5G and 6G, etc.), such as an SMF with PGW control plane functionality (e.g., SMF+PGW-C), a UPF with PGW user plane functionality (e.g., UPF+PGW-U), and/or other combined nodes (e.g., an HSS with a UDM and/or UDR, an MME with an AMF, etc.). Also, core devices 122 may include a split core device 122. For example, core devices 122 may include a session management (SM) PCF, an access management (AM) PCF, a user equipment (UE) PCF, and/or another type of split architecture associated with another core device 122, as described herein.

According to an exemplary embodiment, at least some of core devices 122 may include logic of the integrated network slice encryption service, as described herein. For example, a NEF may be configured to interface and communicate with a third party device (e.g., external device 117) and support the integrated network slice encryption service, as described herein. The communication may include a message from the third party device to end device 130 that activates the integrated network slice encryption service at end device 130. Additionally, the communication may include a message from end device 130 to the third party device that indicates network slice information and enables the third party device to provision end-to-end application layer network slice encryption between end device 130 and a network device that provides an application service (e.g., another external device 117). Also, the communication may include a message from the third party device to other core device 122, such as a UPF or similar functioning core device 122 that provisions an encryption service at the application level for a network slice end-to-end.

End device 130 includes a device that may have communication capabilities (e.g., wireless, wired, optical, etc.). End device 130 may or may not have computational capabilities. End device 130 may be implemented as a mobile device, a portable device, a stationary device (e.g., a non-mobile device and/or a non-portable device), a device operated by a user, or a device not operated by a user. For example, end device 130 may be implemented as a smartphone, a mobile phone, a personal digital assistant, a tablet, a netbook, a phablet, a wearable device (e.g., a watch, glasses, etc.), a computer, a gaming device, a music device, an IoT device, a drone, a smart device, a fixed wireless device, a router, a sensor, an automated guided vehicle (AGV), an industrial robot, or other type of wireless device (e.g., other type of UE). End device 130 may be configured to execute various types of software (e.g., applications, programs, etc.). The number and the types of software may vary among end devices 130. End device 130 may include “edge-aware” and/or “edge-unaware” application service clients. For purposes of description, end device 130 is not considered a network device.

According to an exemplary embodiment, end device 130 may include logic of the integrated network slice encryption service, as described herein. For example, according to an exemplary embodiment, end device 130 may include software that manages the integrated network slice encryption service for one or multiple end device applications, as described herein. For example, the integrated network slice encryption service logic may include logic that provisions a prospective application session with end-to-end application layer network slice encryption at end device 130 based on communications with the third party device, as described herein.

According to an exemplary embodiment, the integrated network slice encryption service logic may include an application programming interface (API) and/or another type of interface that may allow one or multiple types of communication between the integrated network slice encryption service logic and native or resident logic of end device 130 (e.g., end device applications, operating system (OS), protocol stack logic, modem, system software, etc.). For example, the integrated network slice service logic may select (or obtain via communication with system logic of end device) network slice information (e.g., single-network slice selection assistance information (S-NSSAI)) pertaining to an end device application and the establishment of a prospective PDU session. The integrated network slice encryption service logic may select or obtain other types of information, such as an identifier of the application service, a uniform resource identifier (URI) or the like (e.g., a network address, a data network name (DNN), etc.) pertaining to external device 117 that hosts the application service, and/or other types of information as described herein (e.g., category of end device 130, QoS metric value, etc.). The integrated network slice encryption service logic and/or end device 130 may generate and transmit a message that includes the information to the third party device.

According to an exemplary embodiment, the integrated network slice encryption service logic may include encryption/decryption algorithms and a key management function. According to some exemplary embodiments, the integrated network slice encryption service logic may include key generation logic.

According to another exemplary embodiment, an end device application, such as a mobile application or another type of application may also include integrated network slice encryption logic, as described herein. According to still other exemplary embodiments, end device 130 may include a combination of centralized integrated network slice encryption service logic and per-end device application integrated network slice encryption service logic (e.g., a mobile application may provide an application service and also include an exemplary embodiment of the integrated network slice encryption service logic).

According to an exemplary embodiment, the integrated network slice encryption service logic may be provisioned, by the third party device, to provide encryption and/or decryption service for a prospective application service session (e.g., packet data unit (PDU) session) associated with an end device application, a network slice, and external device 117, as described herein. End device 130 may establish the application service/PDU session via the network slice, and provide encryption and/or decryption services, at the application layer, as described herein.

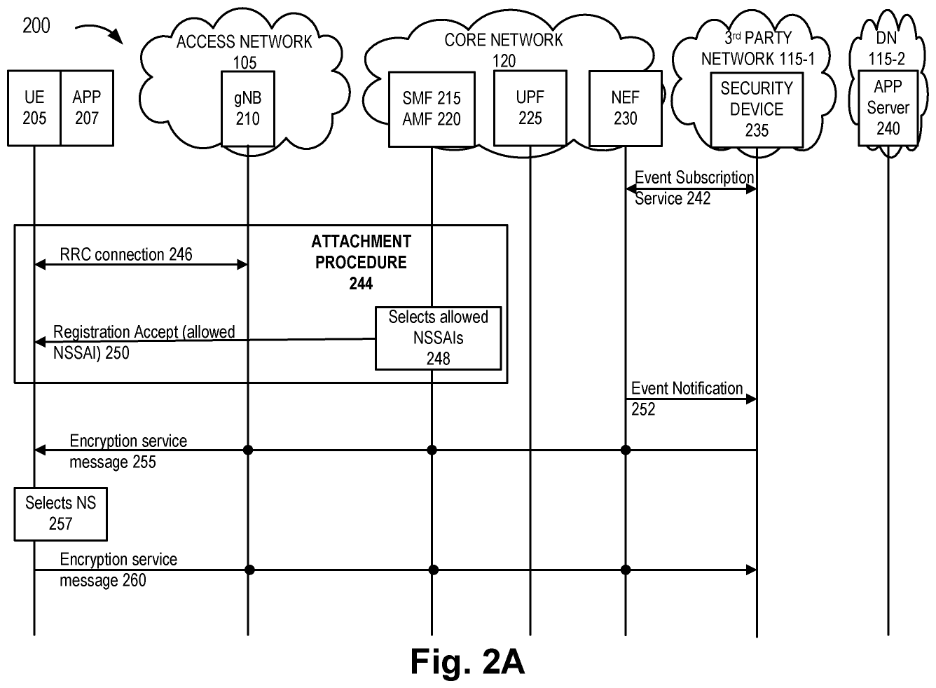

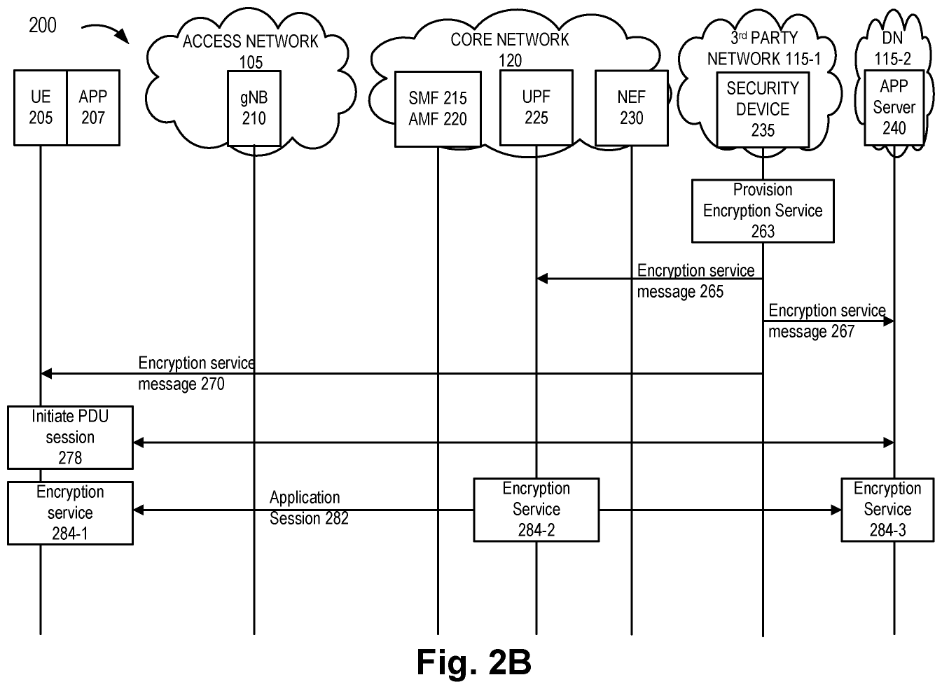

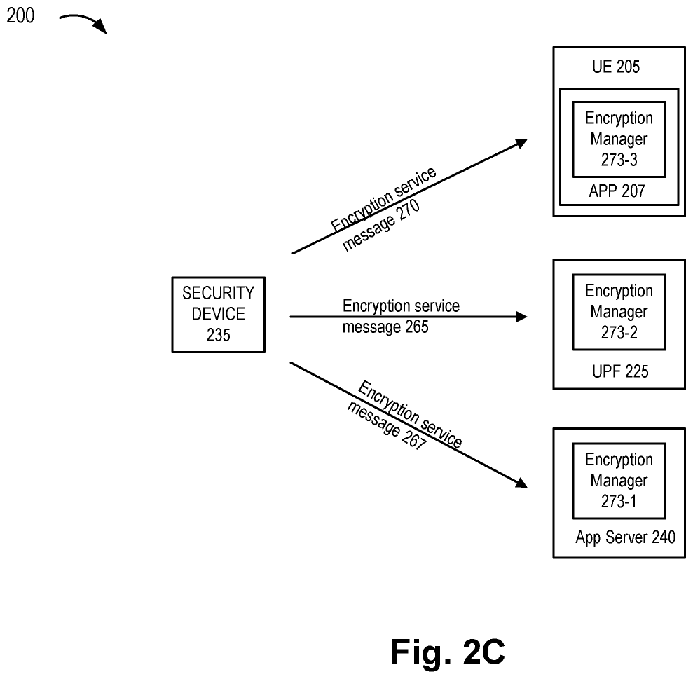

FIGS. 2A and 2B are diagrams illustrating an exemplary process 200 of an exemplary embodiment of the integrated network slice encryption service according to an exemplary scenario. As illustrated, process 200 may be implemented in an environment that includes access device 107, such as gNB 210 and core devices 122, such as an SMF 215, an AMF 220, a UPF 225, and a NEF 230. As described in relation to FIG. 1, according to other exemplary embodiments, the environment may include other types of core devices 122 and access device(s) 107, not specifically illustrated and described in FIGS. 2A and 2B.

As further illustrated, process 200 may be implemented in an environment that includes a third party network 115-1 (e.g., external network 115-1). Third party network 115-1 may include a security device 235 (e.g., external device 117-1). Security device 235 may be configured to provide an exemplary embodiment of the integrated network slice encryption service. The environment also includes a data network (DN) 115-2 (e.g., external network 115-2). Data network 115-2 may include an application server 240 (e.g., external device 117-2) that hosts an application service.

A UE 205 is an implementation of end device 130. UE 205 further includes an application 207. Application 207 may be configured to provide an exemplary embodiment of the integrated network slice encryption service. Application 207 may be implemented in a centralized manner that provides or supports the integrated network slice encryption service on behalf of one or multiple end device applications. Alternatively, application 207 may be implemented as an end device application that provides an application service and also includes logic of the integrated network slice encryption service.

gNB 210 may provide a function and/or a service in accordance with a network standard (e.g., 3GPP, 3GPP2, ITU, ETSI, GSMA, and/or the like) and/or of a proprietary nature. For example, gNB 210 may provide packet processing, baseband processing, radio signal processing, radio resource control, mobility control, session management, and allows end device 130 to connect to core network 120 via an air interface, among other functions. Additionally, for example, gNB 210 may include logic of an exemplary embodiment of the integrated network slice encryption service, as described herein. For example, gNB 210 may receive and transmit messages that support the provisioning and use of the integrated network slice encryption service.

SMF 215, AMF 220, UPF 225, and NEF 230 may each provide a function and/or a service in accordance with a network standard (e.g., 3GPP, 3GPP2, ITU, ETSI, GSMA, and/or the like) and/or of a proprietary nature. For example, SMF 215 may provide session management, Internet Protocol (IP) address allocation and management, selection, and control of user plane (UP) function, configuration of traffic steering, control of policy enforcement and QoS, among other functions. AMF 220 may provide registration, connection, reachability, and mobility management, security context management, location service management, UE mobility event notification, among other functions. UPF 225 may provide an interconnection between a radio access network and a data network (e.g., encapsulation, decapsulation), PDU session anchor point functionality, packet routing and forwarding, uplink classification, application detection, QoS handling, traffic usage reporting, among other functions. NEF 230 may provide secure exposure to services, capabilities, and events of a core network to third party devices and networks, may securely provide information from third party devices and networks to core network/network devices, may provide authentication and authorization services, may provision packet flow descriptors (PFDs) to the SMF, among other functions.

Additionally, for example, SMF 215, AMF 220, UPF 225, and NEF 230 may each include logic of an exemplary embodiment of the integrated network slice encryption service, as described herein. For example, SMF 215, AMF 220, UPF 225, and NEF 230 may receive and transmit messages that support the provisioning and use of the integrated network slice encryption service.

According to an exemplary embodiment, UPF 225 may be provisioned or configured to provide an encryption service at the application level for a network slice and/or triggered or activated to provide the encryption service, as described herein. For example, according to an exemplary embodiment, security device 235 may provide key management information to UPF 225. The key management information may include a key (e.g., symmetric, asymmetric, quantum, and/or the like). UPF 225 may include an encryption/decryption algorithm that supports the encryption key of security device 235. According to an exemplary embodiment, NEF 230 may include an API and/or other form of secure interface that supports communication with security device 235.

Security device 235 may include one or multiple network devices that provides an exemplary embodiment of the integrated network slice encryption service, as described herein. For example, security device 235 may include an AAA device (e.g., an AAA server) or an authentication and authorization (AA) server, an encryption management device, a key management device, and/or another type of security device that may provide or support the encryption/decryption service (e.g., a policy device, a key generator, etc.). Security device 235 may include a database, a data structure, or another form of information repository that may store encryption service information. For example, the encryption service information may map or correlate network slice information (e.g., single-network slice selection assistance information (S-NSSAI)) to security information. The security information may include encryption/decryption algorithm identifiers, key identifiers, and/or keys. The encryption service information may include other types of information that may mapped or correlated, such as end device application identifiers and/or external network identifiers. Security device 235 may provision the integrated network slice encryption service at end device 130, core device 122, and external device 117, as described herein, based on the encryption service information.

Application server 240 may provide an end device application service. Application server 240 may be implemented as a third party network device in an external network 115, such as data network 115-2. Application server 240 may include logic of an exemplary embodiment of the integrated network slice encryption service, as described herein.

The messages illustrated and described are exemplary. According to an exemplary embodiment, the messages may be implemented to include Hypertext Transfer Protocol (HTTP) messages, Radio Resource Control (RRC) messages, and other protocol messages associated with a 5G system. According to other exemplary embodiments, the messages may be implemented using a protocol different from that described and/or include additional, different, and/or fewer instances of data or information. Additionally, process 200 may include additional messages and/or communications between core devices 122, access device 107, end device 130, and/or another network device not specifically described and illustrated.

Referring to FIG. 2A, according to an exemplary scenario, security device 235 and NEF 230 may perform an event subscription service procedure 242 that may create a subscription to an event of a reporting service. For example, the event subscription service may provide notification to security device 235 when the event occurs. According to an exemplary embodiment, the event may relate to when an end device 130 (e.g., UE 205) is attached to access network 105 and/or core network 120. Although not illustrated, NEF 230 may communicate with another core device 122 to establish the event reporting service, such as a UDM. According to an exemplary implementation, the event reporting service establishment procedure may include the exchange of HTTP messages. According to various exemplary embodiments, the integrated network slice encryption service may be provided to any end device 130 (which may be associated with, for example, the network operator of access network 105 and core network 120), end devices 130 that may be of a certain tier of wireless service, end devices 130 that may include a certain end application (e.g., hosted by application server 240), and/or other types of criteria. According to some exemplary embodiments, the third party associated with third party network 115-1 and application server 240 may be the same.

Thereafter, UE 205 may initiate an attachment procedure 244. For example, attachment procedure 244 may include establishing a radio resource control (RRC) connection 246 with gNB 210. Additionally, attachment procedure 244 may include authentication and registration procedures with core network 120. Although not illustrated, the authentication procedure may include AMF 220 as well as involve other core devices 122 (not shown), such as an AUSF, a UDM, etc. AMF 220 may also participate in the initial registration of UE 205 with core network 120 based on an end device identifier of UE 205. As a part of the registration procedure, UE 205 may transmit a registration request, which may include a request for NSSAI (not illustrated). In response to receiving the registration request, AMF 220 may select allowed NSSAI 248 for UE 205. AMF 220 may generate and transmit a registration accept 250, which may include allowed NSSAI, to UE 205.

Based on the completion (or during thereof) of the attachment procedure, NEF 230 may generate and transmit an event notification 252 to security device 235. Although not illustrated, SMF 215, AMF 220, UPF 225, and/or another core device 122 not illustrated (e.g., a UDM, PCF, and so forth) which may participate in the attachment procedure may trigger and communicate backend messages regarding the attachment/registration of UE 205, and subsequently the transmission of event notification 252. Event notification 252 may include the network address (e.g., IP address) of UE 205. The event notification 252 may include other information of relevance for establishing the integrated network slice encryption service at UE 205, such as an end device identifier (e.g., Subscription Permanent Identifier (SUPI) or the like), attachment context information, and/or other information of relevance.

As further illustrated, in response to receiving the event notification, security device 235 may generate and transmit a message 255 that may invoke, indicate availability for use, and/or provision the integrated network slice encryption service at UE 205. For example, encryption service message 255 may include an IE or another type of data instance that activates application 207 in providing the integrated network slice encryption service. Encryption service message 255 may include other types of information for communicating with security device 235 and/or referencing the encryption service, such as the network address of security device 235 (e.g., an IP address or the like) and an encryption service identifier which may identify an encryption service session to which encryption service message 255 pertains. According to some exemplary embodiments, although not illustrated, application 207 and security device 235 may perform a security procedure (e.g., authentication, authorization, etc.).

According to an exemplary implementation, as illustrated, encryption service message 255 may be routed from NEF 230 via SMF 215, AMF 220, and gNB 210 to UE 205 as a control plane message. According to other exemplary implementations, encryption service message 255 may be routed as a user plane message and/or routed via additional or different network devices of the control plane.

According to the exemplary scenario, in response to receiving encryption service message 255 or thereafter (e.g., a user may launch an application on UE 205), UE 205 and/or application 207 may select a network slice 257, which may be used for the prospective end device application service session (e.g., a PDU session), based on the allowed NSSAI(s). For example, UE 205 and/or application 207 may select an S-NSSAI based on a UE Route Selection Policy (URSP) and associated descriptors (e.g., traffic descriptor, application descriptor, route selection descriptor, etc.). According to this exemplary scenario, the end device application may relate or correspond to an application of application server 240 of DN 115-2. In response to the selection, UE 205 and/or application 207 may generate a message 260, such as encryption service message 260. According to an exemplary embodiment, encryption service message 260 may include the selected S-NSSAI. According to an exemplary embodiment, encryption service message 260 may include other types of information, such as an identifier of the end device application, an identifier, a URI, a data network name (DNN), a fully qualified domain name (FQDN), a network address, and/or the like pertaining to DN 115-2 and/or application server 240. UE 205 may transmit encryption service message 260 to security device 235 and according to a route and/or manner similar to that of encryption service message 255, as described herein.

Referring to FIG. 2B, based on receiving message 260 and the information included in message 260, security device 235 may provision the encryption service 263 for the network slice and the prospective application service session between UE 205 and application server 240. For example, security device 235 may select an encryption key to be used by UE 205, UPF 225, and application server 240. Security device 235 may generate and transmit encryption service messages 265, 267, and 270, respectively to UPF 225, application server 240, and UE 270 for the provisioning of the encryption service.

For example, referring to FIG. 2C, as illustrated, application server 240 may include an encryption manager 273-1, UPF 225 may include an encryption manager 273-2, and application 207 of UE 205 may include an encryption manager 273-3. Encryption managers 273-1, 273-2, and 273-3 may be referred to collectively as encryption managers 273 or individually or generally as encryption manager 273. According to various exemplary embodiments, encryption manager 273 may include one or multiple encryption/decryption algorithms (referred to simply as encryption algorithms). According to various exemplary embodiments, the encryption algorithm may include symmetric encryption and/or asymmetric encryption. For example, the encryption algorithm may include one or multiple types of encryption algorithms, such as data encryption standard (DES), triple data encryption algorithm (TDEA), advanced encryption system (AES), a Ron Rivest, Adi Shamir, and Leonard Adleman (RSA) encryption algorithm, an elliptic curve cryptography (ECC) algorithm, a hybrid encryption algorithm, or another known and/or proprietary encryption algorithm.

According to an exemplary embodiment, encryption manager 273 may include a key management system. For example, the key management system may generate keys and/or store keys for encryption/decryption. The keys may be of a single length (e.g., 768 bit or another bit length) or the keys may have variable lengths depending on the end device application, performance metrics (e.g., latency, throughput, etc.) associated with the end device application, the network slice, level of security, and/or other types of context information of relevance.

Encryption service messages 265, 267, and 270 may each include encryption service information to facilitate the provisioning of the integrated network slice encryption service. According to an exemplary embodiment, the encryption service information may include an identifier that identifies an encryption algorithm. According to an exemplary embodiment, the encryption service information may include an identifier that identifies a key. According to another exemplary embodiment, the encryption service information may include a key. Based on encryption service messages 265, 267, and 270, UPF 225, application server 240, and UE 205 may provision the integrated network slice encryption service, from end-to-end at the application layer, in relation to a prospective end device application service session via the network slice.

According to other exemplary embodiments, although not illustrated, security device 235 may provision other user plane intermediary nodes within DN 115-2, such as a security proxy, a router, a firewall, and the like. In this way, the user plane intermediary nodes may offer a service provider, a third party network 115-1, security device 235, and UE 205/user additionally secure slicing capabilities. The intermediary nodes may have access to the same encryption/decryption capabilities associated with the integrated network slice encryption service/framework, as described herein.

Referring back to FIG. 2B, UE 205 may initiate a PDU session establishment procedure 278. According to this exemplary scenario, UE 205 may wish to establish a PDU session with application server 240 via the selected network slice. Although not illustrated, PDU session establishment procedure 278 may include SMF selection, PCF selection, UPF selection, among other operations. For example, SMF 215 may select a PCF and initiate an SM policy association with a PCF (not illustrated). SMF 215 may receive a 5G QoS identifier (5QI)/QoS information, which may pertain to the network slice/DN 115-2, from the PCF. SMF 215 may provide the 5QI/QoS information to gNB 210.

Thereafter, an application session 282 via the network slice between UE 205 and application server 240 may take place in which end-to-end third party encryption at the application layer may be integrated with service provider (e.g., associated with access network 105 and/or core network 120) and/or other layer encryption protection (e.g., at the transport layer and/or another layer of the Open Systems Interconnection (OSI) model) managed by the service provider and/or the application provider. For example, encryption services 284-1, 284-2, and 284-3 may include encryption at the application payload level for data transmitted during application session 275 between UE 205 and application server 240. For example, the encryption services may include decrypting and reading the PDU information and encrypting the PDU for appropriate processing and forwarding of the data.

The messages illustrated and described are exemplary. According to other exemplary embodiments, process 200 may include additional and/or different messages not specifically described and illustrated. According to other exemplary embodiments and scenarios, process 200 may include additional operations, fewer operations, and/or different operations that may be performed. For example, one or more operations of process 200 may be performed after the PDU session is established.

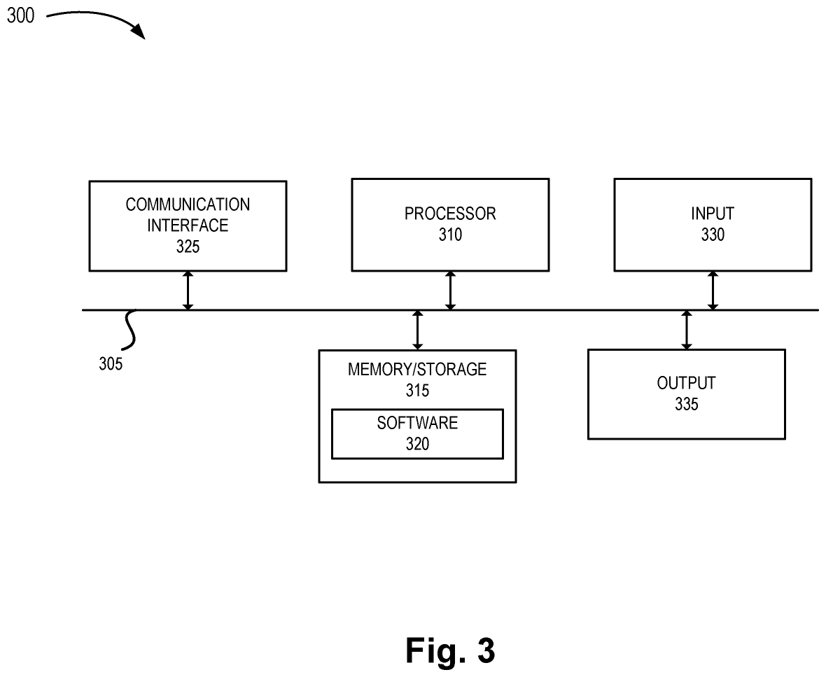

FIG. 3 is a diagram illustrating exemplary components of a device 300 that may be included in one or more of the devices described herein. For example, device 300 may correspond to access device 107, external device 117, core device 122, end device 130, UE 205, gNB 210, SMF 215, AMF 220, UPF 225, NEF 230, security device 235, application server 240, and/or other types of devices, as described herein. As illustrated in FIG. 3, device 300 includes a bus 305, a processor 310, a memory/storage 315 that stores software 320, a communication interface 325, an input 330, and an output 335. According to other embodiments, device 300 may include fewer components, additional components, different components, and/or a different arrangement of components than those illustrated in FIG. 3 and described herein.

Bus 305 includes a path that permits communication among the components of device 300. For example, bus 305 may include a system bus, an address bus, a data bus, and/or a control bus. Bus 305 may also include bus drivers, bus arbiters, bus interfaces, clocks, and so forth.

Processor 310 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 310 may be implemented as hardware (e.g., a microprocessor, etc.), a combination of hardware and software (e.g., a SoC, an ASIC, etc.), may include one or multiple memories (e.g., cache, etc.), etc.

Processor 310 may control the overall operation, or a portion of operation(s) performed by device 300. Processor 310 may perform one or multiple operations based on an operating system and/or various applications or computer programs (e.g., software 320). Processor 310 may access instructions from memory/storage 315, from other components of device 300, and/or from a source external to device 300 (e.g., a network, another device, etc.). Processor 310 may perform an operation and/or a process based on various techniques including, for example, multithreading, parallel processing, pipelining, interleaving, learning, model-based, etc.

Memory/storage 315 includes one or multiple memories and/or one or multiple other types of storage mediums. For example, memory/storage 315 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 315 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 315 may be external to and/or removable from device 300, such as, for example, a Universal Serial Bus (USB) memory stick, a dongle, a hard disk, mass storage, off-line storage, or some other type of storing medium. Memory/storage 315 may store data, software, and/or instructions related to the operation of device 300.

Software 320 includes an application or a program that provides a function and/or a process. As an example, with reference to end device 130/UE 205, software 320 may include an application that, when executed by processor 310, provides a function and/or a process of integrated network slice encryption service, as described herein. Additionally, for example, with reference to UPF 225 and application server 240, software 320 may include an application that, when executed by processor 310, provides a function and/or a process of integrated network slice encryption service, as described herein. Software 320 may also include firmware, middleware, microcode, hardware description language (HDL), and/or other form of instruction. Software 320 may also be virtualized. Software 320 may further include an operating system (OS) (e.g., Windows, Linux, Android, proprietary, etc.).

Communication interface 325 permits device 300 to communicate with other devices, networks, systems, and/or the like. Communication interface 325 includes one or multiple wireless interfaces, optical interfaces, and/or wired interfaces. For example, communication interface 325 may include one or multiple transmitters and receivers, or transceivers. Communication interface 325 may operate according to a protocol stack and a communication standard.

Input 330 permits an input into device 300. For example, input 330 may include a keyboard, a mouse, a display, a touchscreen, a touchless screen, a button, a switch, an input port, a joystick, speech recognition logic, and/or some other type of visual, auditory, tactile, affective, olfactory, etc., input component. Output 335 permits an output from device 300. For example, output 335 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 300 may be implemented in the same manner. For example, device 300 may be instantiated, created, deleted, or some other operational state during its life-cycle (e.g., refreshed, paused, suspended, rebooting, or another type of state or status), using well-known virtualization technologies. For example, access device 107, core device 122, external device 117, and/or another type of network device or end device 130, as described herein, may be a virtualized device.

Device 300 may perform a process and/or a function, as described herein, in response to processor 310 executing software 320 stored by memory/storage 315. By way of example, instructions may be read into memory/storage 315 from another memory/storage 315 (not shown) or read from another device (not shown) via communication interface 325. The instructions stored by memory/storage 315 cause processor 310 to perform a function or a process described herein. Alternatively, for example, according to other implementations, device 300 performs a function or a process described herein based on the execution of hardware (processor 310, etc.).

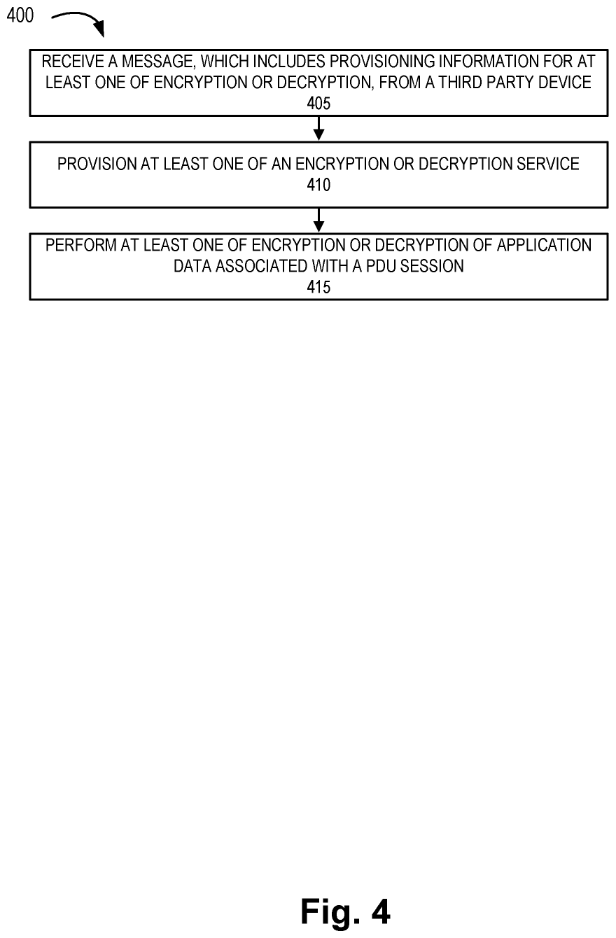

FIG. 4 is a flow diagram illustrating yet another exemplary process 400 of an exemplary embodiment of the integrated network slice encryption service. According to an exemplary embodiment, a core device 122 of a core network 120, such as a UPF or similar functioning core device 122 may perform a step of process 400. According to an exemplary implementation, processor 310 executes software 320 to perform a step of process 400, as described herein. Alternatively, a step may be performed by execution of only hardware. As such, core device 122 may be configured to provide process 400.

In block 405, core device 122 may receive a message, which includes provisioning information for at least one of encryption or decryption, from a third party device. For example, core device 122 may receive an encryption service message from security device 235, as described herein.

In block 410, core device 122 may provision at least one of an encryption or decryption service. For example, core device 122 may select an encryption and/or decryption algorithm based on the encryption service message. According to various exemplary embodiments, core device 122 may select and/or generate a key for providing encryption and/or decryption in relation to a prospective PDU session associated with a network slice and end device application service.

In block 415, core device 122 may perform at least one of encryption or decryption of application data associated with a PDU session. For example, core device 122 may apply encryption and/or decryption to application payload data associated with the PDU session of the network slice, end device 130, and external device 117 (e.g., application server 240).

FIG. 4 illustrates an exemplary process of the integrated network slice encryption service, according to other exemplary embodiments, the integrated network slice encryption service may perform additional operations, fewer operations, and/or different operations than those illustrated and described.

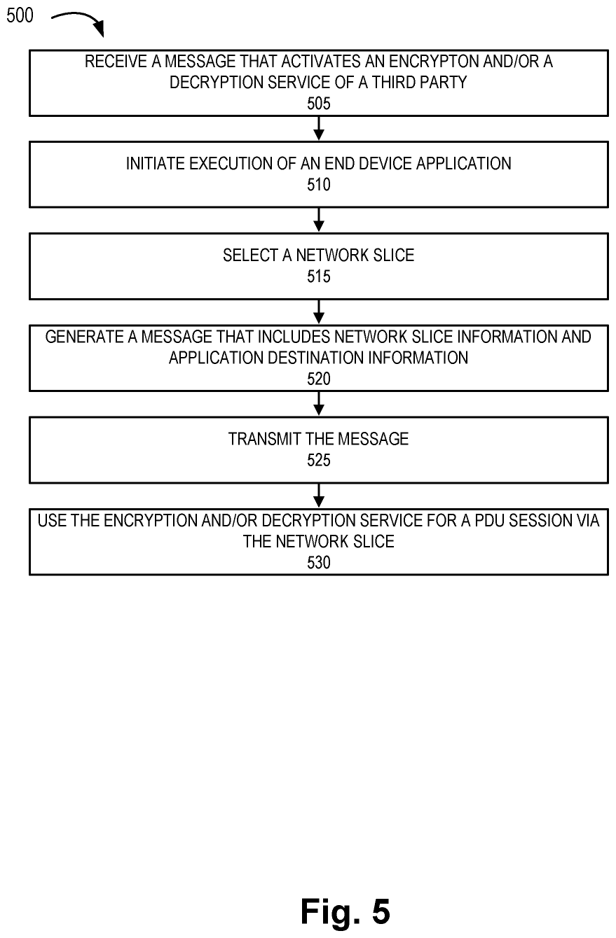

FIG. 5 is a flow diagram illustrating yet another exemplary process 500 of an exemplary embodiment of the integrated network slice encryption service. According to an exemplary embodiment, end device 130 may perform a step of process 500. According to an exemplary implementation, processor 310 executes software 320 to perform a step of process 500, as described herein. Alternatively, a step may be performed by execution of only hardware. As such, end device 130 and/or application 200 may be configured to provide process 500, in whole or in part. A step of process 500 may be performed cooperatively between end device 130 and application 200.

In block 505, end device 130 may receive a message that activates an encryption and/or decryption service. For example, end device 130 may receive the message from security device 235, as described herein. The message may active the integrated network slice encryption service (e.g., application 207), as described herein.

In block 510, end device 130 may initiate execution of an end device application. For example, a user or another triggering event may initiate the execution of the end device application.

In block 515, end device 130 may select a network slice. For example, application 207 and/or end device 130 may select the network slice based on a URSP policy and/or another type of end device configuration.

In block 520, end device 130 may generate a message that includes network slice information and application destination information. For example, application 207 and/or end device 130 may generate the message that includes a selected S-NSSAI to use for the prospective PDU session/application service session and the end device application.

In block 525, end device 130 may transmit the message. For example, application 207 and/or end device 130 may transmit the message to security device 235.

In block 530, end device 130 may use the encryption and/or decryption service for a PDU session via the network slice. For example, application 207 and/or end device 130 may encrypt and/or decrypt application data/packet payload associated with the end device application, the network slice, and the PDU session.

FIG. 5 illustrates an exemplary process of the integrated network slice encryption service, according to other exemplary embodiments, the integrated network slice encryption service may perform additional operations, fewer operations, and/or different operations than those illustrated and described. For example, end device 130 and/or application 207 may receive provisioning information (e.g., encryption service message) from security device 235. End device 130 and/or application 207 may provision the integrated network slice encryption service based on the provisioning information, as described herein.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while a series of blocks have been described regarding the processes illustrated in FIGS. 4 and 5, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 310, etc.), or a combination of hardware and software (e.g., software 320).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 310) of a device. A non-transitory storage medium includes one or more of the storage mediums described in relation to memory/storage 315. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known are expressly incorporated herein by reference and are intended to be encompassed by the claims.

What is claimed is:

1. A method comprising:
receiving, by a core device of a core network from a third party device, provisioning information for at least one of encryption or decryption;
provisioning, by the core device, at least one of an encryption service or a decryption service at the core device; and
performing, by the core device, the at least one of the encryption service or the decryption service relative to application data associated with a packet data unit (PDU) session of a network slice.

2. The method of claim 1, wherein the provisioning information includes an identifier for at least one of an encryption algorithm or a decryption algorithm.

3. The method of claim 1, wherein the provisioning information includes an identifier for a key to be used to perform the at least one of the encryption service or the decryption service.

4. The method of claim 1, wherein the provisioning information is received by the core device via a network exposure function.

5. The method of claim 1, wherein the provisioning occurs before the PDU session is established.

6. The method of claim 1, wherein the provisioning comprises:
selecting, by the core device based on the provisioning information, a key to be used to perform the at least one of the encryption service or the decryption service.

7. The method of claim 1, wherein the provisioning comprises:
selecting, by the core device based on the provisioning information, at least one of an encryption algorithm or a decryption algorithm.

8. The method of claim 1, wherein the core device includes a user plane function.

9. A network device comprising:
a processor that is configured to:
receive, from a third party device, provisioning information for at least one of encryption or decryption, wherein the network device is a core device of a core network;
provision at least one of an encryption service or a decryption service at the network device; and
perform the at least one of the encryption service or the decryption service relative to application data associated with a packet data unit (PDU) session of a network slice.

10. The network device of claim 9, wherein the provisioning information includes an identifier for at least one of an encryption algorithm or a decryption algorithm.

11. The network device of claim 9, wherein the provisioning information includes an identifier for a key to be used to perform the at least one of the encryption service or the decryption service.

12. The network device of claim 9, wherein the provisioning information is received by the network device via a network exposure function.

13. The network device of claim 9, wherein the provisioning occurs before the PDU session is established.

14. The network device of claim 9, wherein the processor is further configured to:
select, based on the provisioning information, a key to be used to perform the at least one of the encryption service or the decryption service.

15. The network device of claim 9, wherein the processor is further configured to:
select, based on the provisioning information, at least one of an encryption algorithm or a decryption algorithm.

16. The network device of claim 9, wherein the core device includes a user plane function.

17. A non-transitory computer-readable storage medium storing instructions executable by a processor of a core device of a core network, wherein the instructions are configured to:
receive, from a third party device, provisioning information for at least one of encryption or decryption;
provision at least one of an encryption service or a decryption service at the core device; and
perform the at least one of the encryption service or the decryption service relative to application data associated with a packet data unit (PDU) session of a network slice.

18. The non-transitory computer-readable storage medium of claim 17, wherein the provisioning information includes an identifier for at least one of an encryption algorithm or a decryption algorithm.

19. The non-transitory computer-readable storage medium of claim 17, wherein the provisioning information includes an identifier for a key to be used to perform the at least one of the encryption service or the decryption service.

20. The non-transitory computer-readable storage medium of claim 17, wherein the core device includes a user plane function.
